(19) United States
(12) Patent Application Publication
(10) Pub. No.: US 2007/0061368 A1
(43) Pub. Date: Mar. 15, 2007

(54) SYSTEM AND METHOD FOR ISSUE-CENTRIC COMMUNICATIONS MANAGEMENT

(75) Inventors: Christopher James JOHNSON, Ottawa (CA); Trevor BOICEY, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: DNA 13 INC., Ottawa (CA)

(21) Appl. No.: 11/531,924

(22) Filed: Sep. 14, 2006

Related U.S. Application Data
(60) Provisional application No. 60/716,497, filed on Sep. 14, 2005.

(51) Int. Cl. G06F 17/00

(52) U.S. Cl. 707/104.1

(57) ABSTRACT

An issue-centric information management system for facilitating and increasing the efficiency of a communications department by providing a comprehensive and robust methodology to track all activity that relates to a corporate communications issues, public affairs issues, investor relations issues, or other sets of issues affecting a group of cooperating individuals. To support the methodology, the system can include a software implementation that supports and assists the system by providing a method of storage and retrieval of pertinent data, as well as to facilitate interaction between the various individuals implementing the communications strategy. The software implementing the system can facilitate tracking all “transactions” that occur related to any given corporate issue. The centralizing of all data and events relating to a communications issue allows the complete picture of all strategy regarding the issue to be seen with the effects of the actions taken. This allows a complete view of all facets of the problem and permits powerful analysis and accurate decision-making.

### CROSS REFERENCE TO RELATED APPLICATIONS

This application claims the benefit of priority of U.S. Provisional Patent Application No. 60/716,497, filed on Sep. 14, 2005.

### FIELD OF THE INVENTION

The present invention relates to the field of information data management.

### BACKGROUND OF THE INVENTION

Corporate issues can be extremely complex, and as a result many actions completed by many individuals are required to manage the issue effectively. Several people typically manage issues and it is desirable to share key tactical information with others in groups and organizations.

An issue can be characterized as a single concept, a single goal, a single product, or other single entity that all actions are in support of, and all events are in reference to. In practice, an issue can include tangible targets, such as a product or product line, a project, a competitor, or an industry sector such as Telecommunications for example. An issue can also include specific challenges or controversies that must be addressed, such as a scandal or a public failure, or any ongoing challenge that affects the company's efforts, such as energy pricing fluctuations for example. Those skilled in the art will understand that a business should not only be aware of information generated by external sources about a particular issue, but should be able to act quickly to address the issue in the most appropriate manner in order to mitigate the impact of such information, especially if such information is negative in nature. In contrast, information of a positive nature should be taken advantage of, with the most appropriate action being taken to further promote the business. Unfortunately, existing information management systems track these external sources in a decentralized manner, without tying actions and data together by the underlying issue.

One management technique implemented by Vocus, tracks communications related activity but does not seek to unify all other related actions by issue. This methodology is limited, as it does not provide the ability to track all corporate communications activities back to the issue, and therefore does not demonstrate the ability to display or analyze this information in any meaningful way.

Another existing technique implemented in the Performa product, by MediaMap, is designed primarily to manage media campaigns and gain exposure in the market. In this methodology, data is grouped by the media outlet with which the communication occurred. While this does provide some level or organization and simple analysis and tracking, it does not allow the analytical depth and the relating of actions to the underlying communications issue or strategy. It also does not connect the interactions with media to other actions or events that these interactions may have affected or created.

Therefore, existing communications management methodologies and software have not taken a holistic view of the workflow of a corporate communications and public affairs organization. Other parties have developed methodologies and tools to manage communications activities, however none of these techniques provide the depth of analytics and reporting as a system that relates all activities back to a corporate issue. The result are systems that create “islands” of information that are not able to be leveraged in order to properly evaluate how a corporate issue is being managed based on interactions, data, and media coverage, and the passage of time.

It is therefore desirable to implement a system where information from disparate sources and multiple participants can be organized by the issue they apply to, and this information is available in a timely manner to help shape actions and reactions as the issue unfolds.

### SUMMARY OF THE INVENTION

It is an object of the present invention to obviate or mitigate at least one disadvantage of previous communications management methodologies. In particular, it is an object of the present invention to provide a method and system for organizing information from disparate sources by issue.

In a first aspect, the present invention provides a method for managing communications information. The method includes creating an issue, logging information data relating to the issue and saving the information data onto mass storage means, and executing reports for compiling logged activities based on predetermined criteria. According to an embodiment of the present aspect, the step of creating an issue can include defining parameters of the issue. According to another embodiment, the step of defining parameters can include inputting issue details, creating a local contact list, and attaching media monitoring search terms. According to yet another embodiment, the step of creating a local contact list can include selecting the issue, searching for contacts from a global contact list, and selecting contacts from the global contact list to include in the local contact list.

According to aspects of the present embodiment, the step of attaching media monitoring search terms includes creating search criteria, adding search terms, associating the search terms to the issue, and setting an alert. The step of logging activities can include logging an incoming call, which includes identifying and recording a calling individual from the local contact list, selecting the issue corresponding to the incoming call, and selecting a call response from a predetermined list of responses.

According to another aspect of the present embodiment, the step of logging activities includes logging an incoming email message, which includes logging an incoming email message can include identifying and recording an emailing individual from the local contact list, selecting the issue corresponding to the incoming email message, and selecting an email response from a predetermined list of responses.

According to a further aspect of the present embodiment, the step of logging activities includes associating editorial calendar events to the issue, which includes searching for editorial opportunities matching a predetermined criteria, adding matched editorial opportunities to a master list, and selecting a subset of matched editorial opportunities to associate to the issue.

According to yet another aspect of the present embodiment, the step of logging activities can include saving media content, which includes selecting one of the media monitoring search terms associated with the issue, viewing a listing of media content including the one of the media monitoring search terms, and saving the media content.

According an embodiment of the present aspect, the step of logging activities includes creating an event, which includes selecting an event type from a predetermined list of events, recording event details, selecting the event, and generating an event alert. The step of recording event details includes entering a date and time of the event, and entering a location of the event. Alternately, the step of recording event details includes entering personnel names for participating in the event.

In further embodiments of the present aspect, step of executing reports can include generating listings of information data matching a predetermined criteria, or generating statistical outputs corresponding to a predetermined criteria.

In a second aspect, the present invention provides a communications management system. The system includes an issue creation module, a contact list creation module, a search module, a media engine, a media content saving module, a call module, an editorial calendar module, an email module, and an event management module. The issue creation module generates an issue record. The contact list creation module generates a local listing of individuals linked to the issue record. The search module receives and links media search terms to the issue record. The media engine executes a search for media content including the media search terms. The media content saving module stores the media content onto mass storage means and links media content matching the media search terms to the issue record. The call module receives and links telephone call information to the issue record. The editorial calendar module receives an links editorial opportunities to the issue record. The email module receives and links email information to the issue record. The event management module receives and links event information to the issue record.

### BRIEF DESCRIPTION OF THE DRAWINGS

Embodiments of the present invention will now be described, by way of example only, with reference to the attached Figures, wherein:

FIG. 1 is a graphical illustration showing workflow operations associated with an issue, according to an embodiment of the present invention;

FIG. 2 is a flow chart of an issue creation method, according to an embodiment of the present invention;

FIG. 3 is a flow chart of a contact list creation method, according to an embodiment of the present invention;

FIG. 4 is a flow chart of an incoming or outgoing call management method, according to an embodiment of the present invention;

FIG. 5 is a flow chart of an incoming or outgoing email management method, according to an embodiment of the present invention;

FIG. 6 is a flow chart of an event management method, according to an embodiment of the present invention;

FIG. 7 is a flow chart of an editorial calendar creation method, according to an embodiment of the present invention;

FIG. 8 is a flow chart of a media search method, according to an embodiment of the present invention;

FIG. 9 is a flow chart of a media content saving method, according to an embodiment of the present invention;

FIG. 10 is an illustration of an issue management system architecture, according to an embodiment of the present invention; and,

FIG. 11 is an illustration showing details of the mass storage means and the database of FIG. 10.

### DETAILED DESCRIPTION

The present invention is directed to a methodology and system that enables users to track all interactions such as calls, documents, media monitoring mentions, email transactions, journalists related or associated with each issue, as well as any changes in how the corporate issue is being portrayed or presented to stakeholders. This methodology and system, called an issue management system, will provide organizations with the ability to track multiple dimensions of data back to a single corporate issue, and thus have the ability to report on and analyze actions, results, and quantify performance on each issue of importance.

The embodiments of the present invention facilitate and increase the efficiency of a communications department by providing a comprehensive and robust methodology to track all activity that relates to corporate communications issues, public affairs issues, investor relations issues, or other sets of issues affecting a group of cooperating individuals. This tracking methodology is implemented by storing and retrieving pertinent information data, all linked to a particular issue.

This is primarily achieved by associating all data and events relating to an issue, which allows the complete picture of all strategy regarding the issue to be seen with the effects of the actions taken. This allows a complete view of all facets of the problem and permits powerful analysis and accurate decision-making.

According to an embodiment of the present invention, every external source information data can be logged, or stored in the system by issue. From this point forward, information data will include query information such as telephone calls and emails, and media activities such as Internet, television news reports, radio reports, printed newspaper articles, and magazine articles. Furthermore, other relevant information can be linked to the particular issue. For example, event management, editorial calendars, contact lists, and searches can be associated with each issue.

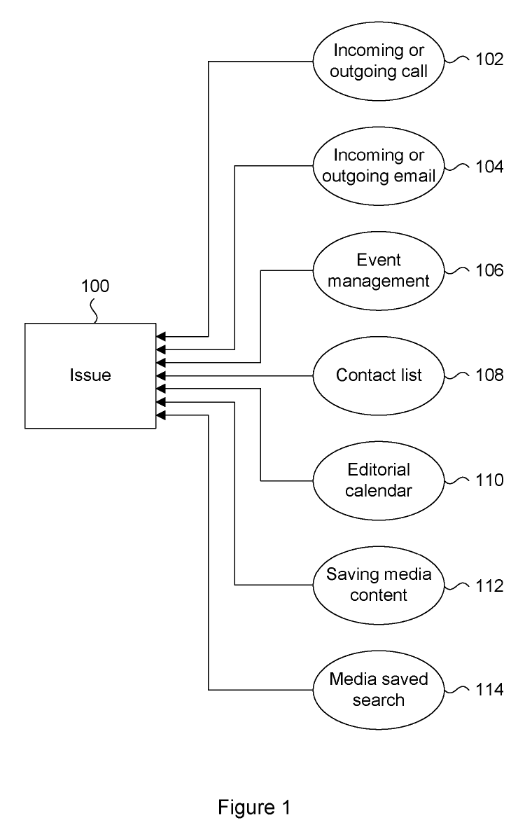

FIG. 1 is a graphical illustration showing the workflow operations, or modules, which are used to manage information data for a particular issue for the issue management system embodiment of the present invention. In FIG. 1, the issue 100 exists within the system as a record having a specific profile defined upon its creation. The profile of the issue 100 will be discussed in more detail later. In the present embodiment, there are seven different modules that each execute management routines for linking the specific type of information data to the issue 100. These are the call module 102, email module 104, and event management module 106, a contact list module 108, and editorial calendar module 110, a media content storage module 112, and a search module 114.

Each aforementioned workflow operation, or module, is implemented as a software routine running on a central server, or a remote processing device, that supports and assists the system by providing a method of storage and retrieval of pertinent data, as well as to facilitate interaction between the various individuals implementing the communications strategy.

The software implementing the system will also facilitate tracking all “transactions” that occur related to any given issue. For example, tracking incoming and outgoing telephone calls to and from media personnel is required, incoming and outgoing email to reporters or stakeholders are tracked, any media mentions (broadcast, Internet, print, or any other media) that relate to the issue are tracked, any events such as press releases, interviews, meetings or editorial calendar possibilities are tracked back to the issue, and all electronic documents and media lists are tracked to the corporate issue.

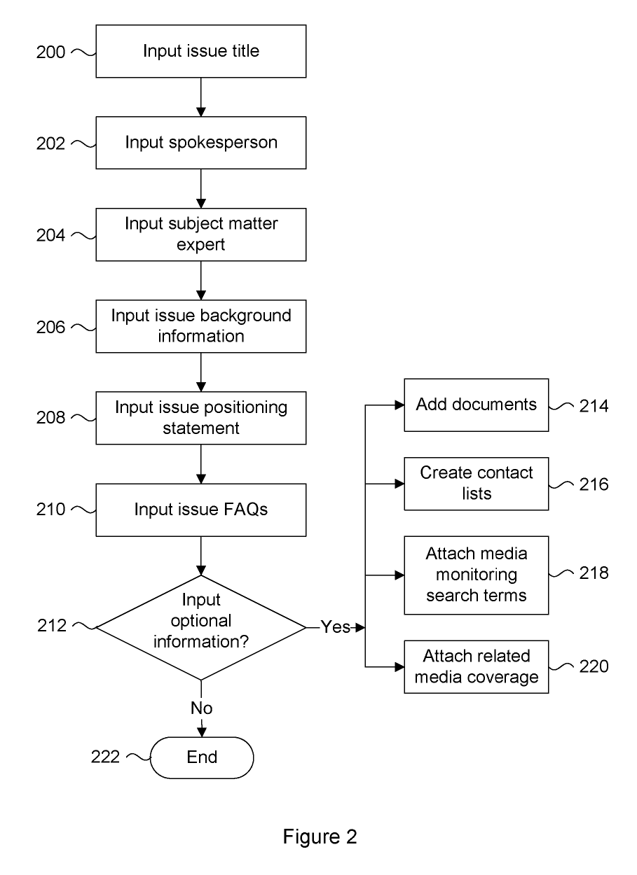

Firstly though, an issue record must first be created before any activities can be logged and used by a group of users. The system encourages the storage and publication of the definition of the strategic objectives and tactics to properly manage the issue. These strategies can be stored with the issue so that all team members using the system and involved in the issue will present a unified strategy to further the group's interests. FIG. 2 is a flow chart showing how an issue is created. The issue record is created in the system database by first assigning an appropriate title to the issue at step 200. At step 202, a spokesperson is assigned to the issue. The spokesperson is preferably the primary contact for the issue. To complement the spokesperson, a subject matter expert relating to the issue is assigned at step 204. A membership list can be included, which can be the team assigned to handle the issue. Now general information relating to the issue is added, starting with the entry of background information at step 206. This background information can outline the reason the issue has arisen. At step 208 an issue positioning statement is entered, which summarizes the corporate stance on the issue, or a desired end result for resolving the issue. A frequently asked questions (FAQ) field can be populated at step 210 with collected questions and previously given answers relating to the issue.

At this point, the issue is essentially created. However, at step 212, the user is queried for additional optional information to associate with the newly created issue. This can include the attachment of specific documents relating to the issue. For example as shown in FIG. 2, the user can attach any relevant documents at step 214 (marketing material for example), create contact lists (of stakeholders, for example) at step 216, attach media monitoring search terms at step 218, and attach press clippings relating to the issue at step 220. Alternately, if no additional information is to be added, then the process ends at step 222. The issue/project creation method shown in FIG. 2 creates the initial issue and provides the ability for users to adopt the methodology. Once created, the issue is available to associate multiple transactions to it within the database.

According to an embodiment of the present invention, each issue can be divided into hierarchies, such as by geography, by business line or by corporate structure, etc. In this way, transactions that are tied to issues can further be interpreted and analyzed to determine their significance to various sub-regions and sub-groups that may be in the organization. This further allows analysis to determine which issues may be affected by significant events, and vice versa.

Therefore, each issue is defined by several data points, such as its stakeholders, it's core strategies and core definitions. Once the system is loaded with the complete list of issues, it is ready for use. From this moment, all actions of the group should be related to one of these issues. The system provides for a quick and efficient method of creating these relationships. These aforementioned actions can be captured by the previously discussed modules from FIG. 1.

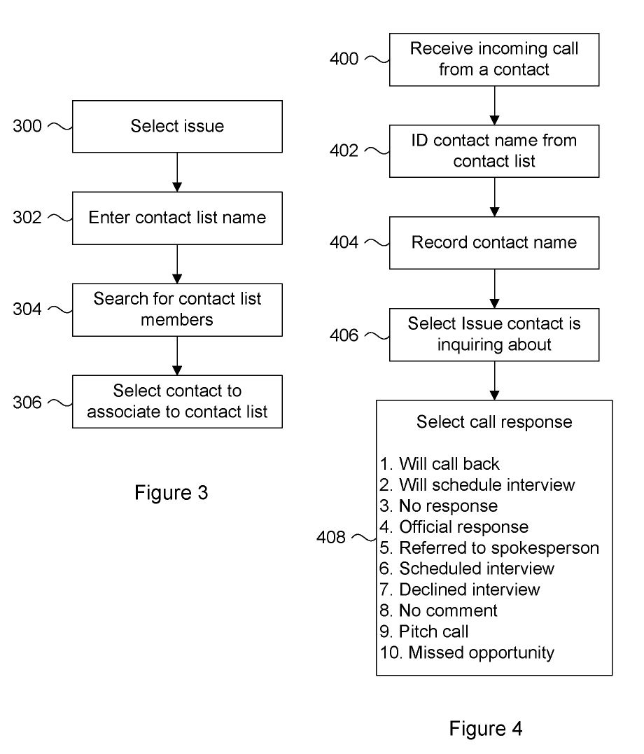

FIG. 3 is a flow chart outlining the contact list creation module 108 of FIG. 1. The contact list for the issue can be created as part of the issue creation routine of FIG. 2, or can be created at a later time. Preferably, the system shared by all the users includes a global contact list. This module will create and add contacts from the global contact list to a local contact list associated with a particular issue. The process starts at step 300, where a specific issue is selected. This can be done by entering the issue title or selecting the issue from a drop down menu. The user will then create a new contact list, and enter a suitable name for the list at step 302. At step 304, the user will search through the global contact list for individuals to associate to the local contact list. This can be done by entering the contact name, or selecting the name to be added to the local contact list. If the global contact list does not include a desired individual, then they can be added as a new contact directly into the local contact list. The addition of the new contact, preferably adds the new contact to the global contact list. If the search locates the desired individual in the global contact list, they can be selected to be added to the local contact list at step 306. The local contact list can be updated at any time.

FIG. 4 is a flow chart outlining the incoming or outgoing call management module 102 of FIG. 1. This module will not only log the call, it will allow the user to log the response made to the call for other users to see. Generally, this module creates a record populated with information tied to the issue. The process starts at step 400, where an incoming call has been received. At step 402, the name of the caller is identified from the global contact database of the system, and once found, can be selected at step 404. If the caller is not a part of global contact database, then they can be added and then selected. The particular issue the caller is inquiring about is then selected at step 406. At this point, if this is the first time the issue is raised, then the issue can be created according to the issue creation routine of FIG. 2. At step 408, a specific call response is selected, which notifies other users about the response that was given to the caller.

The listing of response options shown in step 408 of FIG. 4 is not intended to be comprehensive, and merely illustrates the types of response categories that can be selected. Response options 1 and 2 in step 408 are illustrative of call logs that are considered pending, while remaining options 4 to 10 are illustrative of call logs that are considered closed.

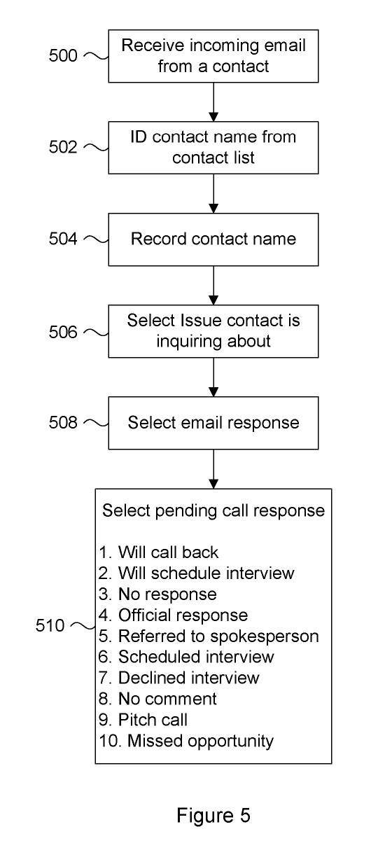

In FIG. 5, the incoming or outgoing email management module 104 of FIG. 1 proceeds in very much the same as in FIG. 4. This module will not only log the email message, it will allow the user to log the response made to the email message for other users to see. Generally, this module creates a record populated with information tied to the issue. The process starts at step 500, where an incoming email message has been received. At step 502, the name of the email sender is identified from the global contact database of the system, and once found, can be selected at step 504. If the sender is not a part of global contact database, then they can be added and then selected. The particular issue the sender is inquiring about is then selected at step 506. Once again, the issue can be created if it is a new issue. At step 508, a specific email response is selected, which notifies other users about the response that was given to the caller.

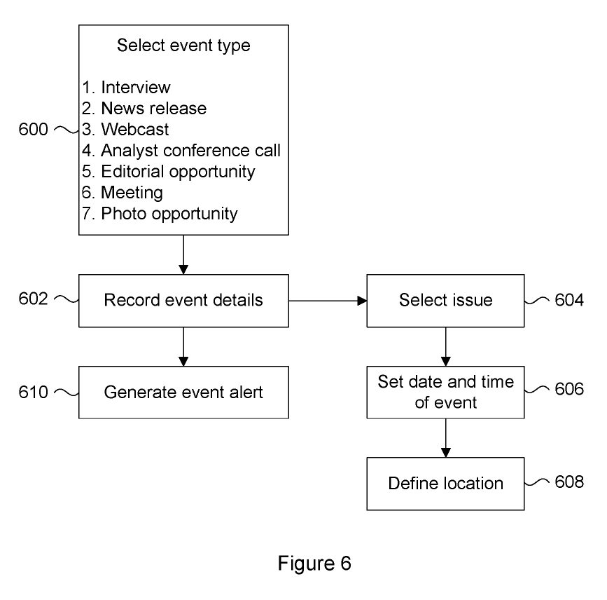

FIG. 6 is a flow chart outlining the event management module 106 of FIG. 1. This module will log any one of a variety of events related to the issue. The process starts at step 600 by selecting a specific type of event. This can include an interview, a news release, a webcast, an analyst conference call, an editorial opportunity, a meeting or a photo opportunity. Details of the event are entered at step 602, which include a selection of the issue it relates to at step 604, the date and time of the event at step 606, and the location of the event at step 608. Of course, additional event-specific details can be added, as can the individuals who should be involved with the event itself. For example, one or more individuals can be identified for participating in the event, a communications manager can be assigned, as can a definition of executive involvement in the event. Once the event has been created and defined, alerts can be generated at step 610 to notify the members of the issue that an event has been created. This alert can take the form of a text message, email message, or telephone message, for example.

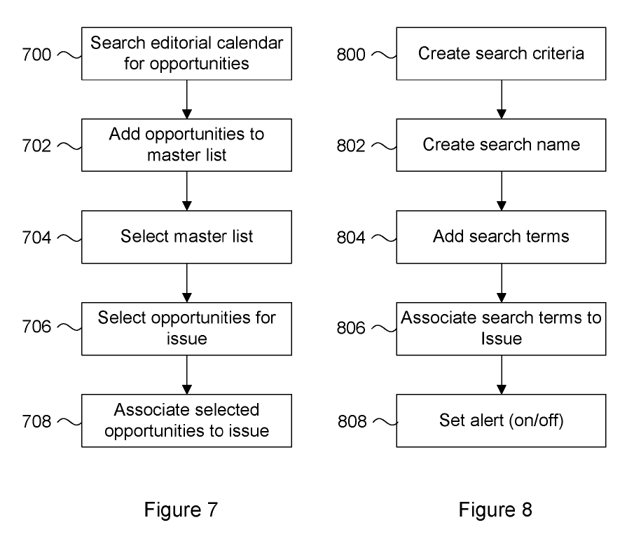

FIG. 7 is a flow chart outlining the editorial calendar module 110 of FIG. 1. This module allows a user to create and associate editorial opportunities to an issue. An editorial opportunity is a potential publishing activity by a media publication, where a specific article or story can be submitted for consideration or inclusion. Typically, each media publication establishes due dates for receiving submissions for the corresponding print date. The process starts at step 700 where a search of an editorial calendar is conducted for opportunities. Identified editorial opportunities are selected and added to a master list in step 702. Any number of master lists can be created, as each list can include only those opportunities that meet a predetermined criteria. Therefore, steps 700 and 702 can be repeated. At step 704, the user can select a specific master list from which an issue list is to be created. At step 706, a specific subset of opportunities in the selected master list are selected. This subset of opportunities (the issue list) is then associated with the issue, by selecting the desired issue at step 708.

FIG. 8 is a flow chart outlining the media search module 114 of FIG. 1. This module allows a user to create and associate search terms to an issue. These search terms can be used by commercially available or proprietary media search engines to identify media content that contain them. Content such as video, email and other media can be received by any means and logged by any user. The content can be stored/logged using proprietary or commercial file management software, with the desired fields to enable storage and cross-referencing of the file to a specific issue. For example, a user may be notified by a real-time media searching and alerting system that issue-relevant media has been broadcast. One example of a known search engine is the real-time media searching an alerting system disclosed in commonly owned U.S. patent application Ser. No. 11/063,559, filed on Feb. 24, 2005. This system monitors video clips and corresponding closed captioned text, which can be stored and cross-referenced to one or more issues of interest.

The method of FIG. 8 starts with the creation of search criteria at step 800. This can include searching specific sources, such as the Internet and/or television broadcasts, originating from a geographic location for example. A search name is assigned for the search criteria at step 802, and then specific search terms are added at step 804. The search name and terms are then associated with a particular issue at step 806. At step 808, the user can elect to turn on an alert, which notifies one or more team members if the search returns any “hits”. Now the various search engines can begin their search to find media containing the search terms.

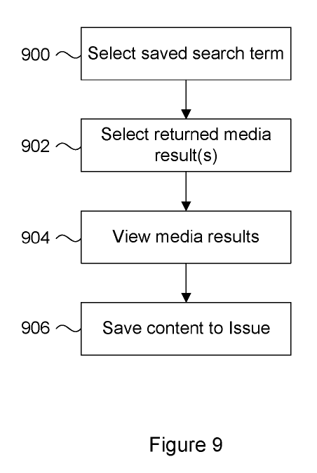

FIG. 9 is a flow chart outlining the media content saving module 112 of FIG. 1. This module 112 is typically executed after an alert is received from the media search module of FIG. 8, indicating that a “hit” has occurred. However, the present media content saving module can be executed at a scheduled time by the user. The process starts at step 900, where a saved search term is selected. By selecting a saved search term, the returned media content from the search for that search term are displayed at step 902. At step 904, the user has the option of view the returned media content, be it print, video or Internet. At step 906, the user can save the media content to a specific issue.

All the previously described modules permit a user to save and store information pertaining to the issue, which is available for all other team members to view. The embodiment of the invention is not limited to logging the information shown in the figures. The system is expandable such that any conceivable event or action can be logged to the issue. Therefore, the tracking of data and events and “tying” them back to the central issue allows full-circle management of the entire process, allowing the production of reports (media monitoring, media call-logs, events, media lists as well as detailed issue-based analytics) pertaining to all issues across the organization.

With all the information stored in the system, users can formulate reports and/or queries based on issues, or based on the geography/business unit that the issues are relevant to. Relationships can be derived both from being tied to the same issue was well as being tied to issues that share similar traits. According to an embodiment of the present invention, the issue management system can include an analysis engine and a simple reporting engine. The analysis engine executes operations for assembling and presenting information according to selected criteria to the user, while the reporting engine produces statistical outputs relating to an issue.

As an example simple analysis, a user could request all of the calls that occurred with regards to issue “xyz”. The system will then produce this list by returning all calls that have this relationship, for review by the user.

As an example of more abstract analysis, the user can request all of the media content that affects an Asian office. The system will then perform a search of all of the issues that are geographically affecting Asia, and then returns all the media content. The system can sort the media content by issue, if so desired.

As an example of simple reporting, the system can generate a graph of all calls by issue. This will have the function of determining which issues are generating the most calls.

As an example of more in depth reporting, the system can generate a graph of all media content generated by business line. This will be performed by determining which issues affect which business lines (where each business line corresponds to an issue), and then graphing the total number of calls tied to all of these issues.

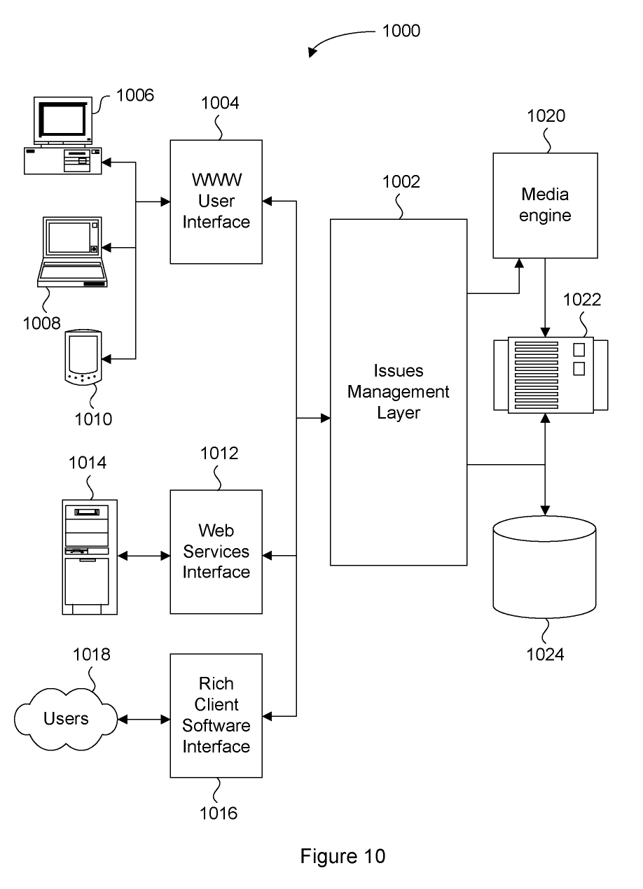

The previously described routines of the issue management system are preferably executed on a networked computing system, as shown in FIG. 10. FIG. 10 is an illustration of the issue management system architecture 1000, according to an embodiment of the present invention. This diagram shows the various hardware and functional components that can be used to enable implementation. The Issues Management Layer 1002 can be implemented in software running on a central server for example, and is responsible for executing functions such as organization/management of issue-centric information as they are logged or received, and serving user requests for information. More specifically, the Issues Management Layer 1002 executes the previously described modules.

Users can access the Issues Management Layer 1002 through a variety of interfaces. A world wide web (WWW) user interface 1004 is included for allowing users to access the Issues Management Layer 1002 with computer workstation 1006, laptop computer 1008 or personal digital assistant (PDA) 1010 with web capability. A web services interface 1012 is included for enabling remote servers 1014 to access to Issues Management Layer 1002. A rich client software interface 1016 is included for enabling users 1018 with personal computers to execute many local operations, while gaining access to the Issues Management Layer 1002 (via the Internet). Those skilled in the art will understand that wireless communications is another means for communicating with the Issues Management Layer 1002.

The issue management system architecture 1000 can include a media engine 1020 responsible for conducting immediate or ongoing searches of media sources for articles and video segments including the search terms associated with each stored issue. The media engine can be a collection of different media content search tools. Monitored articles and/or video segments can be stored in the mass storage means 1022, or just those articles and video segments that include the search terms can be stored. A database 1024 is included for storing all the issue records, and related information associated with the issues.

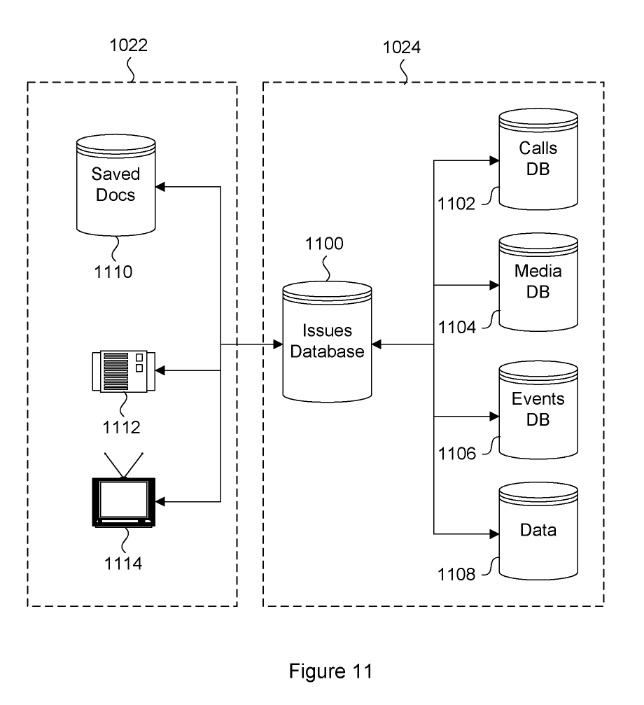

FIG. 11 is an illustration of the types of information that can be associated to an issue, and how they can be linked, or referenced, to an issue. In the presently shown embodiment, the database 1024 of FIG. 10 can consist of an issues database 1100, an incoming/outgoing calls database 1102, a saved media content database 1104, an events database 1106, as well as other data, symbolically represented here for brevity as database 1108. The additional data can include contact lists, email conversations and contact lists generated via MS-Outlook, search terms, reports, generated statistics and analytics, shared notes, and all other information that is storable in the system and is pertinent to this issue.

The mass storage means 1022 can be implemented as one or more hard disk drives, and can consist of a saved documents drive 1110, a saved files drive 1112, and a saved video/audio drive 1114. All the aforementioned databases and drives can be centrally stored, or distributed across the network.

The issues database 1100 can be a listing of issues and pointers to content stored in the other databases, which themselves can include further pointers to content stored in the mass storage means 1022. When a user requests all the information presently compiled for a specific issue, the specific content is retrieved from each of the individual databases and/or drives as required.

Therefore, the embodiments of the present invention facilitates and improves the communications efforts of a group as it relates to a particular issue.

The invention is of value to individuals who work in the communications and public affairs realm as well as those holding specific positions that are tied to the communications function such as legal, human resources and marketing communications. The individuals use the software and methodology to more effectively manage internal and external communications issues that affect the company, its policies, and its reputation.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for managing communications information, comprising:
a) creating an issue;
b) logging information data relating to the issue, and storing said information data onto mass storage means; and
c) executing reports for compiling logged activities based on predetermined criteria.

2. The method for managing communications information of claim 1, wherein the step of creating an issue includes defining parameters of the issue.

3. The method for managing communications information of claim 2, wherein the step of defining parameters includes inputting issue details, creating a local contact list, and attaching media monitoring search terms.

4. The method for managing communications information of claim 3, wherein the step of creating a local contact list includes selecting the issue, searching for contacts from a global contact list, and selecting contacts from the global contact list to include in the local contact list.

5. The method for managing communications information of claim 3, wherein the step of attaching media monitoring search terms includes creating search criteria, adding search terms, associating the search terms to the issue, and setting an alert.

6. The method for managing communications information of claim 3, wherein the step of logging activities includes logging an incoming call.

7. The method for managing communications information of claim 6, wherein the step of logging an incoming call includes identifying and recording a calling individual from the local contact list, selecting the issue corresponding to the incoming call, and selecting a call response from a predetermined list of responses.

8. The method for managing communications information of claim 3, wherein the step of logging activities includes logging an incoming email message.

9. The method for managing communications information of claim 8, wherein the step of logging an incoming email message includes identifying and recording an emailing individual from the local contact list, selecting the issue corresponding to the incoming email message, and selecting an email response from a predetermined list of responses.

10. The method for managing communications information of claim 1, wherein the step of logging activities includes associating editorial calendar events to the issue.

11. The method for managing communications information of claim 10, wherein the step of associating editorial calendar events includes searching for editorial opportunities matching a predetermined criteria, adding matched editorial opportunities to a master list, and selecting a subset of matched editorial opportunities to associate to the issue.

12. The method for managing communications information of claim 1, wherein the step of logging activities includes creating an event.

13. The method for managing communications information of claim 12, wherein the step of creating an event includes selecting an event type from a predetermined list of events, recording event details, selecting the event, and generating an event alert.

14. The method for managing communications information of claim 13, wherein the step of recording event details includes entering a date and time of the event, and entering a location of the event.

15. The method for managing communications information of claim 13, wherein the step of recording event details includes entering personnel names for participating in the event.

16. The method for managing communications information of claim 3, wherein the step of logging activities includes saving media content.

17. The method for managing communications information of claim 16, wherein the step of saving media content includes selecting one of the media monitoring search terms associated with the issue, viewing a listing of media content including the one of the media monitoring search terms, and saving the media content.

18. The method for managing communications information of claim 1, wherein the step of executing reports includes generating listings of information data matching a predetermined criteria.

19. The method for managing communications information of claim 1, wherein the step of executing reports includes generating statistical outputs corresponding to a predetermined criteria.

20. A communications management system comprising:
an issue creation module for generating an issue record;
a contact list creation module for generating a local listing of individuals linked to the issue record;
a search module for receiving and linking media search terms to the issue record;
a media engine for executing a search for media content including the media search terms;
a media content saving module for storing the media content onto mass storage means, and for linking the media content matching the media search terms to the issue record;
a call module for receiving and linking telephone call information to the issue record;
an editorial calendar module for receiving an linking editorial opportunities to the issue record;
an email module for receiving and linking email information to the issue record; and,
an event management module for receiving and linking event information to the issue record.
